(19) United States
(12) Patent Application Publication
(10) Pub. No.: US 2026/0167584 A1
(43) Pub. Date: Jun. 18, 2026

(54) EXPLOSIVE ADDITIVE

(71) Applicant: Proactive Ground Solutions Pty Ltd, Wangara WA (AU)

(72) Inventor: Drew Anthony MARTIN, Wangara WA (AU)

(73) Assignee: Proactive Ground Solutions Pty Ltd, Wangara WA (AU)

(21) Appl. No.: 19/128,614

(22) PCT Filed: Nov. 10, 2023
(86) PCT No.: PCT/AU2023/051146

§ 371 Date: May 9, 2025

(30) Foreign Application Priority Data
Nov. 11, 2022 (AU) 2022903399

(51) Int. Cl. C06B 31/30; C06B 31/28; C08G 63/08; C08G 63/183; C08G 101/00

(52) U.S. Cl. CPC C06B 31/30; C06B 31/285; C08G 63/08; C08G 63/183; C08G 2101/00

(57) ABSTRACT

An explosive additive for use in bulk or packaged explosives includes a biopolymer, wherein the biopolymer is a bioplastic or a bio-based plastic. The biopolymer may include either or both of polyactide and polybutylene adipate terephthalate. The explosive additive may be in bead form and include a number of foamed beads.

### FIELD OF THE INVENTION

The invention is directed to an explosive additive for use with bulk or packaged explosives.

### BACKGROUND

The following discussion of the background art is intended to facilitate an understanding of the present invention only. It should be appreciated that the discussion is not an acknowledgement or admission that any of the material referred to was part of the common general knowledge as at the priority date of the application.

It is known to use explosive additive (as a bulking agent) with explosives to reduce explosives energy in wet blast hole bulk explosives.

One commonly used explosive additive is expanded polystyrene (EPS) foam, which can be used as a substitute for Porous Prilled Ammonium Nitrated (PPAN).

The most commonly used fuel in ammonium nitrate based bulk explosives is diesel due to its price and availability, although EPS cannot be used with diesel fuelled bulk explosives as the EPS reacts with the diesel and breaks down.

In such cases explosives manufacturers that use EPS in bulk explosives therefore use alternate fuels to diesel, such as vegetable oil or mineral oil, which are more expensive and do not react with the EPS. As a result, such products have only a small market share in surface mining operations and are used only in tunnelling perimeter blast holes in the underground market.

The use of the EPS with alternate fuels results in a high manufacturing cost and there is a need for a bulking additive that does not react with diesel to enable a low-cost alternative bulk Ammonium Nitrate Fuel Oil (ANFO) explosive.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

Throughout the specification unless the context requires otherwise, the phrase “carbohydrate polymer” or variations such as “carbohydrate polymers”, will be understood to include biopolymers, and in particular including polylactide.

### SUMMARY OF INVENTION

According to an embodiment of the invention, there is provided a bulk explosive comprising an explosive additive, wherein the explosive additive comprises a carbohydrate polymer.

In an embodiment, the carbohydrate polymer is a biopolymer.

In an embodiment, the carbohydrate polymer is a polysaccharide.

In an embodiment, the polysaccharide is formed into polylactide expanded foam.

In an embodiment, the carbohydrate polymer comprises polylactide.

In an embodiment, the carbohydrate polymer comprises only polylactide.

In an embodiment, the carbohydrate polymer comprises polylactide without another polymer.

According to another embodiment of the invention, there is provided an explosive comprising an explosive additive, wherein the explosive additive comprises an expanded foam polylactide.

According to another embodiment of the invention. There is provided an explosive additive for bulk or packaged explosives, wherein the explosive additive comprises a biopolymer.

According to another embodiment of the invention, there is provided a method of creating a bulk explosive, the method comprising adding an explosive additive to an explosive base, wherein the explosive additive comprises an expanded foam biopolymer.

According to another embodiment of the invention, there is provided an explosive additive for bulk or packaged explosives, wherein the explosive additive comprises a carbohydrate polymer and polylactide expanded bead foam.

Unless the contrary is apparent, embodiments of the above-described principal aspects, and any of those described below, may comprise or incorporate, either individually or in combination, any of the following features.

In an embodiment, the explosive additive is comprised in a bulk explosive.

In an embodiment, the explosive additive is comprised in a packaged explosive.

In an embodiment, the biopolymer is a bioplastic.

In an embodiment, the biopolymer is a bio-based plastic.

In an embodiment, the biopolymer is polylactide.

In an embodiment, the biopolymer is polybutylene adipate terephthalate (PBAT).

In an embodiment, the biopolymer is a carbohydrate polymer.

In an embodiment, the explosive additive comprises a polymer that is biodegradable.

In an embodiment, the explosive additive comprises a polymer that is compostable.

In an embodiment, the explosive additive comprises a blend of two or more different biopolymers.

In an embodiment, the bulk explosive comprises Ammonium Nitrate Fuel Oil (ANFO).

In an embodiment, the bulk explosive comprises an explosive base.

In an embodiment, the bulk explosive comprises a blasting agent mixture.

In an embodiment, the blasting agent mixture is of a type that is used with fuels that would cause expanded polystyrene to break down if combined.

In an embodiment, the blasting agent mixture comprises an oxidiser. Example oxidisers include any of Porous Prilled Ammonium Nitrate (PPAN), Ammonium Nitrate Solution (ANS) or Ammonium Nitrate Emulsion (ANE).

In an embodiment, the bulk explosive comprises a fuel.

In an embodiment, the fuel is of a type that would cause expanded polystyrene to break down if combined.

In an embodiment, the fuel is diesel.

In an embodiment, the explosive is an ammonium nitrate-based explosive.

In an embodiment, the explosive additive comprises an expandable foam.

In an embodiment, the explosive additive is in bead form, comprising a plurality of foamed beads.

In an embodiment, the beads are less than 50 mm across a greater dimension, preferably less than 20 mm across.

In an embodiment, the foamed beads are formed using a method of extrusion expansion or heat expansion with an expansion or impregnation agent.

In an embodiment, the expansion or impregnation agent is CO₂.

In an embodiment, the explosive additive comprises a polylactide expanded bead foam.

In an embodiment, the biopolymer is polylactide expanded bead foam.

In an embodiment, the bulk explosive comprises up to 50% volume of explosive additive, wherein the explosive additive is configured to act as a bulking agent.

In an embodiment, the bulk explosive comprises less than 5% explosive additive by volume.

Preferably, the bulk explosive comprises between 1% and 3% explosive additive by volume.

According to another embodiment of the invention, there is provided a column of bulk explosive comprising an explosive additive, wherein the explosive additive comprises a biopolymer, and wherein a lower portion of the column comprises a greater density of explosive additive than an upper portion of the column.

In an embodiment, the column is provided in a blast hole.

According to another embodiment of the invention, there is provided a blast hole at least partially filled with bulk explosive, wherein the bulk explosive comprises an explosive additive, wherein the explosive additive comprises a biopolymer, and wherein a toe end of the bulk explosive comprises a greater density of explosive additive than an upper end of the bulk explosive.

According to another embodiment of the invention, there is provided a blast hole at least partially filled with bulk explosive, wherein the bulk explosive comprises an explosive additive, wherein the explosive additive comprises a biopolymer, and wherein a density of explosive additive is different at different depths of the hole.

In an embodiment, the density of the bulk explosive at a given depth in the blast hole is selected according to the depth of the hole.

According to another embodiment of the invention, there is provided a method of at least partially filling a blast hole with bulk explosive, the method comprising the following steps:
a. directing a stream of blended blasting agent mixture and fuel into a blast hole,
b. adding a selected quantity of explosive additive to the stream, wherein the explosive additive comprises a biopolymer.

In an embodiment, adding the selected quantity of explosive additive to the stream below a collar of the hole, so that spill of explosive additive outside of the hole is minimised or prevented.

In an embodiment, varying the rate of explosive additive being added to the stream.

In an embodiment, decreasing the rate of explosive additive being added to the stream, so that a toe end of the hole has a greater density of explosive additive than a surface end of the hole.

In an embodiment, the explosive additive functions as a bulking agent.

In an embodiment, the explosive additive functions as a sensitiser.

In an embodiment, the explosive additive functions as both a bulking agent and a sensitiser.

### DESCRIPTION OF DRAWINGS

In order to provide a better understanding of the present invention examples will now be described with reference to the accompanying drawings, in which:

FIG. 1 shows a bulk explosive according to an embodiment of the invention.

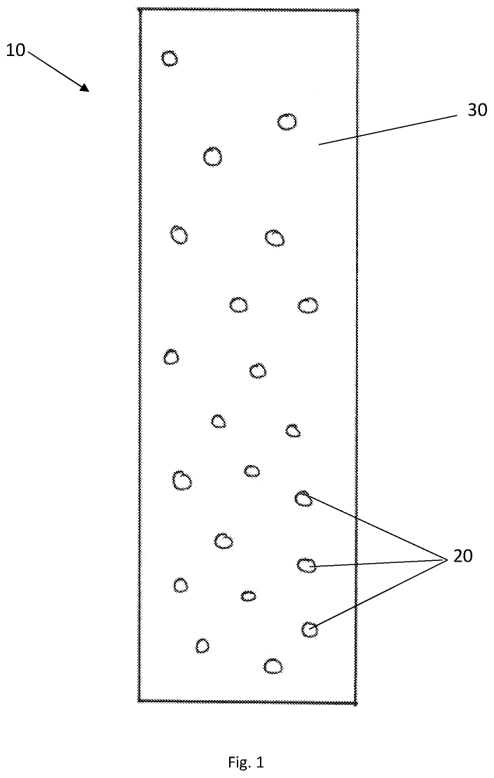

FIG. 2 shows a blast hole being at least partially filled with bulk explosive according to an embodiment of the invention.

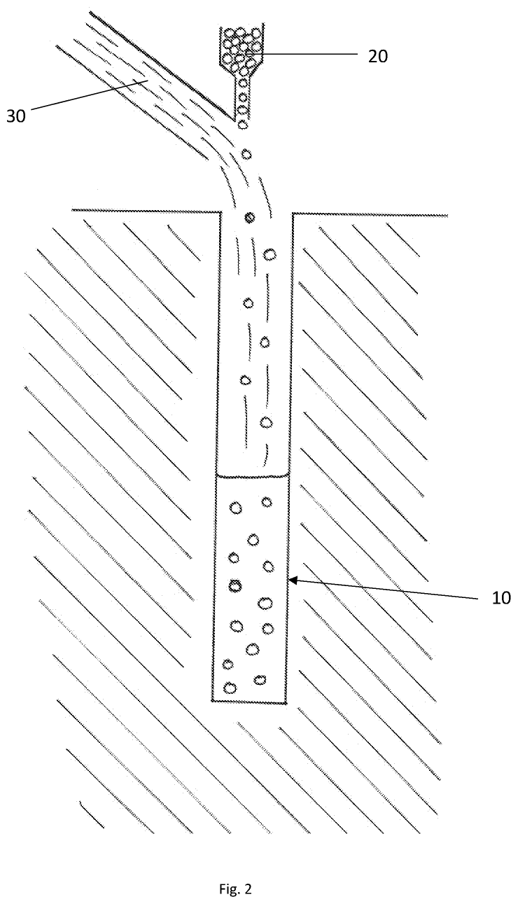

### DESCRIPTION OF EMBODIMENTS

According to an aspect of the invention, there is provided an explosive additive 20 for bulk or packaged explosives 10, wherein the explosive additive 20 comprises a biopolymer.

According to another aspect of the invention, there is provided a bulk explosive 10 with a bulking agent comprising polylactide expanded beads.

According to another aspect of the invention, there is provided a bulk explosive 10 with a bulking agent 20, wherein expanded polystyrene beads are replaced with expanded polylactide beads and a fuel that would typically cause expanded polystyrene beads to break down.

The biopolymer may be a bioplastic or bio-based plastic.

The biopolymer may be polylactide, or polybutylene adipate terephthalate.

The biopolymer may be biodegradable or preferably may be compostable.

The explosive additive 20 may comprise a blend of two or more different biopolymers.

The biopolymer may be a carbohydrate polymer, for example a polysaccharide.

The biopolymer, or carbohydrate polymer, may be of a type that does not break down, in particular when in expanded form, when exposed to fuels such as diesel fuel.

The explosive additive 20 may be added to a bulk explosive base to form bulk explosive 10.

The bulk explosive base may comprise Ammonium Nitrate Fuel Oil (ANFO), or any ammonium-nitrate based explosive.

The bulk explosive 10 may be formed of a blasting agent mixture 30, which may be of a type that is commonly combined with a fuel that reacts with EPS, causing it to break down. An example of such fuel is diesel.

The explosive additive 20 comprising a biopolymer may also be used in a packaged explosive (not shown).

The different amounts of explosive additive 20 may be selected to suit different depths within the hole. For example, packaged explosive comprising a greater amount of explosive additive 20 may be used at the bottom, or toe, of the hole or column of explosive.

The explosive additive 20 may comprise a biopolymer expanded foam, which may be in bead form, comprising a plurality of foamed beads. The beads may be less than 50 mm across, or less than 20 mm across.

The beads may be between 1 mm and 50 mm across.

The size of the beads may be selected according to the application, for example properties of the hole to be charged with bulk explosive 10.

The explosive additive 20 may comprise a polylactide expanded bead foam. By way of example, this foam may be formed in accordance with the process defined in Australian Patent 2019332779 in the name of Natureworks LLC, the contents of which is incorporated herein by reference.

The use of biopolymer foams is advantageous as an alternative to EPS for a number of reasons.

EPS beads break down when exposed to diesel or other petroleum fuels.

The explosive additive 20 comprising biopolymer has been shown to withstand extended periods of exposure to diesel fuel without breaking down.

During a trial 70 litres of explosive additive 20 comprising biopolymer in the form of expanded beads was immersed in a diesel and ANE solution for 8 weeks and displayed negligible breakdown of the beads over this time.

The capability to withstand exposure to diesel fuel means that biopolymer explosive additive 20 can be used as a bulking agent with a blasting agent mixture 30 and diesel fuel 40 in a bulk explosive, which is an application that was not available to EPS bulking agents.

This combination provides a low-cost bulk explosive 10 with diesel as the preferred choice of fuel 40, due to its low cost, and biopolymer explosive additive 20.

A further advantage of carbohydrate polymer explosive additive 20 is its capability to withstand pressure without deformation.

The explosive additive 20 comprising biopolymer has been shown to withstand pressure without deformation, to a greater extent than EPS. This is advantageous as pressure on the bulk explosive 10 can cause desensitisation, resulting in suboptimal detonation.

In particularly deep blast holes, for example greater than 30 m, the static head of pressure is significant on the bulk explosive 10 at the bottom of the hole. Some types of explosives include a chemical sensitiser, which can be forced out due to the pressure, leaving a de-sensitised explosive.

Similarly, air in a bulking agent, for example in EPS foam, may be forced out where the foam is compressed due to the pressure. The heated compressed air drives the chemical reaction during the explosion, and air being forced out due to the compression of the foam before the explosion can also leave a desensitised product.

In comparison, the greater structural integrity of biopolymer explosive additive 20 beads under pressure allows the interstitial spaces between the beads to remain substantially uncompressed, and any chemical in those spaces, for example chemical sensitiser, to remain in the bulk explosive 10.

This enables the use of the explosive additive 20 as a sensitiser.

In addition, the lower compressibility of the foam beads means that the air in the explosive additive 20 is retained to further drive the explosion.

A bulk explosive 10 or packaged explosive 50 using biopolymer explosive additive 20 remains sensitised toward the lower end of deep holes, where a bulk explosive that uses EPS as a bulking agent would become desensitised.

This is at least due to the molecular structure of the biopolymer enabling the explosive additive 20 according to the invention to be less compressible than EPS of broadly equivalent dimensions.

The bulk explosive 10 may be streamed into the hole using a mechanical device, for example an auger.

The bulk explosive 10 blend of the blasting agent mixture 30, explosive additive 20 and fuel 40 may be pre-mixed and fed via into the hole, for example using an auger.

When used as a sensitiser, the bulk explosive 10 may comprise less than 5% explosive additive 20 by volume, for example between 1% and 3%.

When used as a bulking agent, the quantity of explosive additive 20 in a bulk explosive may be up to 50% by volume.

Alternatively, the amount of explosive additive 20 by volume may be adjusted whilst the bulk explosive 10 is being fed into the hole.

This may be achieved by adding in the explosive additive 20 in stream.

In embodiments that provide a variable rate of addition of explosive additive 20 into the stream, this enables the density of the bulk explosive 10 to be different at different depths in the hole by varying the amount of explosive additive 20 according to the depth of the explosive being added into the hole.

The explosive additive 20 may be added into the stream below a collar of the hole, so that the explosive additive 20 is not lost by spillage beyond the hole, or at least any loss is minimised.

Alternatively, in embodiments comprising a string pf packaged explosives 50, the packaged explosives 50 toward the lower end, or toe, of the hole may comprise a greater amount of explosive additive 20, which acts to further sensitise the packaged explosive 50, or to prevent leakage of sensitiser under pressure.

For example, this can be advantageous to overcome issues regarding compression due to static head pressure in deep holes.

Alternatively, different hole properties, such as water in the toe of the hole, or varying levels of dampness, may require different composition of bulk explosive at different depths.

Modifications and variations as would be apparent to the skilled addressee are intended to be covered by the accompanying claims.

1. An explosive comprising an explosive additive, wherein the explosive additive comprises a biopolymer, wherein the biopolymer is a bioplastic or a bio-based plastic.

2. (canceled)

3. The explosive according to claim 1, wherein the biopolymer comprises either or both of polylactide and polybutylene adipate terephthalate.

4. The explosive according to claim 1, wherein the explosive additive comprises only polylactide.

5. The explosive according to claim 1, wherein the explosive additive comprises a polymer that is compostable.

6. The explosive according to claim 1, wherein the explosive additive comprises a blend of two or more different biopolymers.

7. The explosive according to claim 1, wherein the explosive additive comprises an expanded foam.

8. The explosive according to claim 1, wherein the explosive additive is in bead form, comprising a plurality of foamed beads.

9. The explosive comprising an explosive additive, wherein the explosive additive comprises an expanded foam polylactide.

10. The explosive according to claim 1, wherein the explosive is a bulk explosive.

11. The explosive according to claim 1, wherein the explosive is a packaged explosive.

12. The explosive according to claim 10, wherein the bulk explosive comprises Ammonium Nitrate Fuel Oil (ANFO).

13. The explosive according to claim 10, wherein the bulk explosive comprises a blasting agent mixture.

14. The explosive according to claim 10, wherein the bulk explosive comprises up to 50% volume of explosive additive, wherein the explosive additive is configured to act as a bulking agent.

15. The explosive according to claim 10, wherein the bulk explosive comprises less than 5% explosive additive by volume.

16. A method of creating a bulk explosive, the method comprising adding an explosive additive to an explosive base, wherein the explosive additive comprises an expanded foam biopolymer, wherein the biopolymer is a bioplastic or a bio-based plastic.

17. (canceled)

18. A blast hole at least partially filled with bulk explosive, wherein the bulk explosive comprises an explosive additive, wherein the explosive additive comprises a biopolymer, wherein the biopolymer is a bioplastic or a bio-based plastic, and wherein a density of explosive additive is different at different depths of the hole.

19. (canceled)

20. A method of at least partially filling a blast hole with bulk explosive, the method comprising the following steps:
a. directing a stream of blended blasting agent mixture and fuel into a blast hole,
b. adding a selected quantity of explosive additive to the stream before the stream enters the blast hole, wherein the explosive additive comprises a biopolymer, and wherein the biopolymer is a bioplastic or a bio-based plastic.
